(19) United States
(12) Patent Application Publication
(10) Pub. No.: US 2018/0047120 A1
(43) Pub. Date: Feb. 15, 2018

(54) System and Method for Locating Healthcare Providers

(71) Applicant: Cydnei Mathis, Austin, TX (US)

(72) Inventor: Cydnei Mathis, Austin, TX (US)

(21) Appl. No.: 15/674,882

(22) Filed: Aug. 11, 2017

Related U.S. Application Data
(60) Provisional application No. 62/373,398, filed on Aug. 11, 2016.

(51) Int. Cl. G06Q 50/22; G06F 19/00

(52) U.S. Cl. CPC G06Q 50/22; G06F 19/328; G06F 19/322

(57) ABSTRACT

A system and method for locating healthcare providers. The method includes transmitting location information and a series of criteria from a client computer over a network, receiving the transmission at a server, compiling and ranking a list of healthcare providers on a database based on proximity to location information and the series of criteria, transmitting a ranked list of healthcare providers to the client computer, displaying the ranked list of healthcare providers, displaying a route of travel to a selected healthcare provider from the ranked list of healthcare providers. Additionally, the method includes creating a user profile containing medical information, transmitting the user profile to the server, and receiving healthcare tips based on the medical information contained in the user profile on the client computer. The user can further update the database with pricing information for medical treatments received at a specified healthcare provider.

### CROSS REFERENCE TO RELATED APPLICATION

This application claims the benefit of U.S. Provisional Application No. 62/373,398 filed on Aug. 11, 2016. The above identified patent application is herein incorporated by reference in its entirety to provide continuity of disclosure.

### BACKGROUND OF THE INVENTION

The present invention relates to methods for locating affordable healthcare providers. More specifically, the present invention provides a method for identifying affordable healthcare providers based on a series of criteria and directing users to a selected healthcare provider location.

Regular and emergency health costs can be expensive and burdensome for many individuals. Patients may delay scheduling appointments or seeking medical opinions due to the costs associated with such visits. Ignoring a medical issue can lead to complications that may become even more expensive and potentially life threatening. Because of this, many people will consider medical treatment if they can find an affordable option. However, when searching for a healthcare provider, it can be difficult to easily view and compare costs from comparable providers located within a specific area. Accordingly, there is a need for a method of easily identifying medical providers and their costs within a specific area.

### SUMMARY OF THE INVENTION

In view of the foregoing disadvantages inherent in the known types of healthcare provider location methods now present in the prior art, the present invention provides a new system and method for locating healthcare providers wherein the same can be utilized for providing convenience for the user when searching for affordable medical care.

It is therefore an object of the present invention to provide a method for identifying affordable healthcare providers and directing users to the healthcare provider location that has all of the advantages of the prior art and none of the disadvantages.

It is another object of the present invention to provide the ability for users to wirelessly transmit the current location of a client computer, insurance carrier information, and budget constraints to a database via a communications network.

More objectives of the present invention will become apparent in the following detailed description of the figures.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the computer system.

FIG. 2 shows a flowchart of an embodiment of the method of the computer system.

FIG. 3 shows a graphical user interface on a display of the client computer displaying healthcare provide information.

### DETAILED DESCRIPTION OF THE INVENTION

Reference is made herein to the attached drawings. Like reference numerals are used throughout the drawings to depict like or similar elements of the present method. For the purposes of presenting a brief and clear description of the present invention, the preferred embodiment will be discussed as used in conjunction with a mobile device. The figures are intended for representative purposes only and should not be considered to be limiting in any respect.

As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

The present invention provides a method of remotely conveying the location of healthcare providers based on accepted health insurance carrier information, price constraints, and proximity to the location of a user. The present method may be implemented via software stored on a device capable of wirelessly transmitting and receiving information. The method allows users to send their current location to a database having healthcare provider location information stored thereon. The database then transmits a ranked list of healthcare providers to the user based on a series of criteria determined by the user. The method also provides for directing the user to a chosen healthcare provider. The method further provides healthcare tips and diagnoses based on a user profile and symptom information.

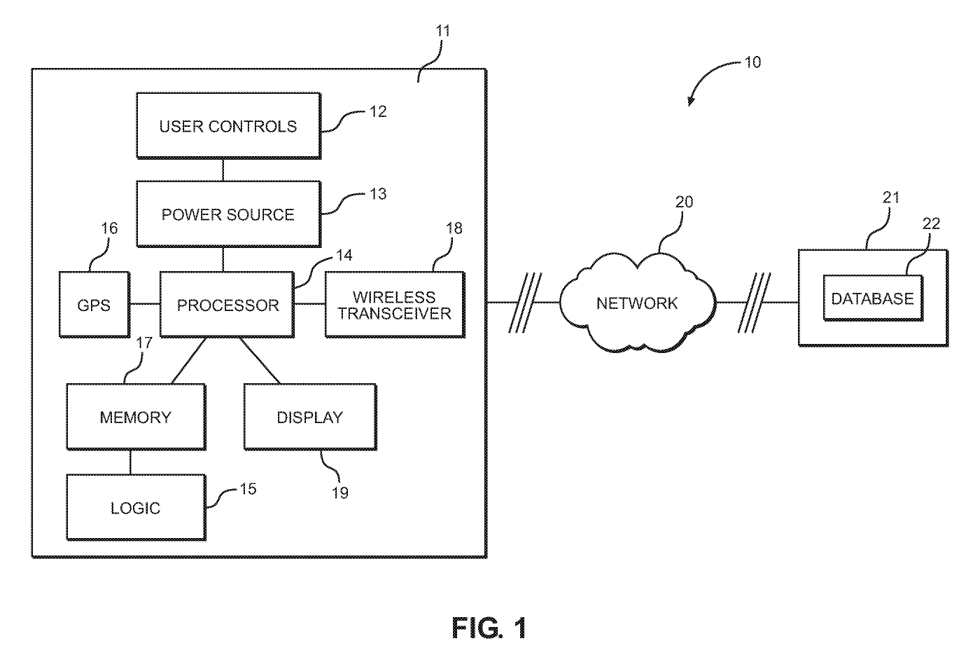

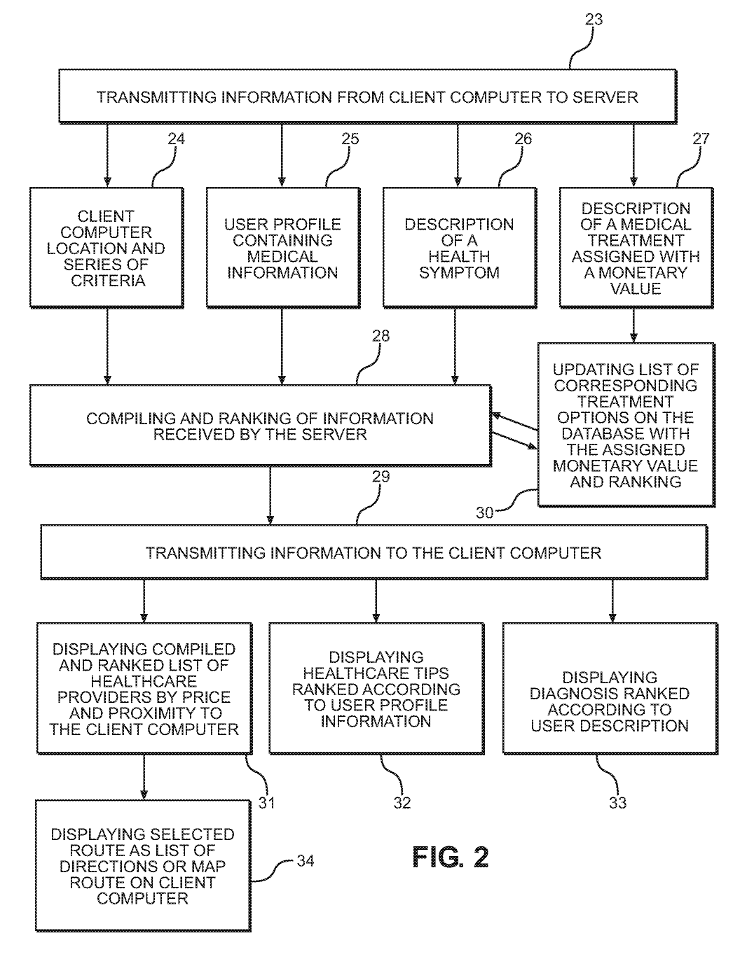

Referring now to FIG. 1 and FIG. 2, there is shown a diagram of the computer system and a flowchart of an embodiment of the method of the computer system, respectively. The computer system 10 comprises a client electronic device 11 configured to communicate with a server 21 to identify relative locations of healthcare providers based on selected criteria that is variably input by a user or preselected. In the shown diagram, the client computer 11 includes user controls 12 operatively connected to a power source 13. The client computer 11 comprises a computer readable medium, which is shown here as a memory 17. The client computer 11 further comprises a processor 14, and a logic 15 stored on the memory 17. When the logic 15 is executed, the processor 14 causes the client computer 11 to perform a method according to the present invention 10.

The client computer 11 further comprises a wireless transceiver 18 that is configured to send and receive information over a network 20, e.g. a telecommunications network, and a GPS system 16 that is configured to monitor the physical location of the client computer 11 via one or more GPS satellites in operative communication therewith. The client computer 11 also includes a display 19. The display 19 is configured to display healthcare provider information and geographic healthcare provider location information. Each of the processor 14, memory 17, wireless transceiver 18, and display 19 are in operative communication with one another and with the power source 13. The client computer 11 may be embodied in a mobile device, such as a smart phone, laptop, or tablet.

In the illustrated embodiment, upon selective actuation, the client computer 11 of the computer system 10 transmits 23 its current location information, which is determined by the GPS system 16, over a wireless network 21 via the wireless transceiver 18. The wireless network 21 may be a cellular network, wireless internet network, or similar.

The logic 15 causes location information of the client computer 11 and a series of criteria entered by a user into a client computer application to be transmitted 23 to a server 21 having a database 22 of healthcare provider information stored on non-transitory memory. The series of criteria 24 entered by the user comprises criteria, such as, health insurance information, proximity restrictions for a healthcare provider within a designated geographic radius of the user's location, and pricing restrictions for medical treatment services. The database 22 includes a listing of healthcare providers, wherein the list further comprises categorical information including the location of each healthcare provider, accepted health insurance at each healthcare provider location, a rating for each healthcare provider, and pricing of medical services per healthcare provider location. In alternative embodiments, the categorical information can include additional categories, such as, doctor reviews and doctor specialty information regarding services performed.

The server 21 compiles a list of healthcare providers and ranks 28 the list of healthcare providers based on the series of criteria provided by the user and the current location 24 of the client computer 11. The ranked list of healthcare providers is transmitted 29 by the server 21 to the client computer 11. In one embodiment, the ranked list of healthcare providers contains only providers that accept the user's health insurance coverage, fall within the chosen geographic radius of the user's location, meet a rating threshold, and offer desired medical treatment options within a designated price range.

Once received, the logic 15 of the client computer 11 is configured to display 31 the ranked list of healthcare providers sent by the server 21. The ranked list is displayed 31 on a graphical user interface (hereinafter “GUI”), wherein the GUI provides a map of an area surrounding the client computer 11 as determined by the GPS system 16 and the ranked list of healthcare providers. Each healthcare provider location is integrated with the map. The GUI shows an approximate distance of each healthcare provider to the current location of the client computer 11. The ranked list can be categorized by provider, distance, and price range. The price associated with a desired medical treatment can be listed from lowest to highest or highest to lowest, depending on the preference of a user. In this way, the user can easily select the most affordable treatment option associated with a healthcare provider that accepts the health insurance of the user.

A user selects a healthcare provider from the ranked list based on their preference. Once the selection is made, the logic 15 of the client computer 11 is configured to display an optimal route of travel to the selected healthcare provider, which is displayed on the display screen 19. The logic 15 may also be configured to display the route of travel on a map or as driving directions in a list format.

In further steps of the method, a user may create a user profile to receive information from the database 22 corresponding to the user profile, such as health tips based on the dietary habits of a user. The user profile is configured to be accessible only by entering a username and password. The user profile is also linked to an email address wherein information can be received. In the illustrated embodiment, the user profile includes medical information 25 such as height, weight, medical symptoms, previous diagnoses, and dietary information. This information is stored within the user profile and transmitted 23 to the server 21 by the transceiver 18 which is directed by the logic 15 of the client computer 11.

The server 21 receives the user profile and compiles 28 the information stored within the profile by comparing it to medical information stored on the database 22. The server 23 then ranks 28 the list of healthcare tips retrieved from the database 22 that correspond to the medical information entered in the user profile. The ranking lists the healthcare tips in order that correlates the best to the user profile, such that a highest ranked tip is most appropriate for a category listed in the user profile. The ranked list of healthcare tips is then transmitted 29 from the server 21 to the client computer 11. The client computer 11 receives and displays 32 the healthcare tips. The logic 15 is configured to store the healthcare tips within the memory 17 of the client computer 11 based on preference of the user. The health tips provide a reminder to the user to continue a certain prescribed plan to maintain a healthier lifestyle, such as, performing a certain exercise or eating a certain type of food to help the rehabilitation process from a previous medical treatment. The health tips are configured to be transmitted 29 from the server 21 to the client computer 11 on a timed basis, such as, daily or weekly, depending on the preference of the user.

In additional steps of the method, a user enters a description of a health symptom 26 on the client computer 11 and transmits 23 the description of the health symptom 26 to the server 21. The server 21 receives the description of the health symptom, then compiles a list of diagnoses from the database 22 that corresponds to the description of the health symptom entered by the user. The server 21 then determines a diagnosis or diagnoses that match the description of the health symptom. In some instances, multiple diagnoses may match the description of the health symptom. In this instance, a ranked list of diagnoses is transmitted 29 to the client computer 11, wherein a first diagnosis in the ranked list is the closet match to the description health symptom. The client computer 11 receives and displays 33 the ranked list of diagnoses so the user can read the result. The illustrated embodiment of the present method allows a user suffering from an illness to type in the symptoms they are experiencing into the client computer application. The resulting diagnosis received allows the user to determine what type of healthcare provider is necessary.

In further steps of the method, a description of medical treatment with an assigned monetary value 27 is transmitted 23 to the server 21 and updated on the database 22. In the illustrated embodiment, a user enters a description of a medical treatment 27 they recently received from a healthcare provider into the client computer 11. The user further enters a monetary value corresponding to the price the user paid for the medical treatment. The logic 15 of the client computer 11 transmits 23 the description of the medical treatment with the accompanying monetary value 27 to the server 21. The server 21 receives the description and monetary value for the medical treatment and updates 30 the database 22, such that the corresponding medical treatment provided by the healthcare provider is updated with the most recent price paid by the user.

This embodiment allows other users of the present method to continually update the database 22 containing the healthcare provider pricing information, such that when a request for a list of healthcare providers by pricing restrictions is sought, the resulting list transmitted contains the most up to date pricing information for each medical treatment. The pricing of medical treatment, maintained on the database, can be updated by both the associated healthcare provider that sets the price of treatment, or another user that recently received and paid for the medical treatment. This allows the database 22 to maintain real time pricing for each medical treatment.

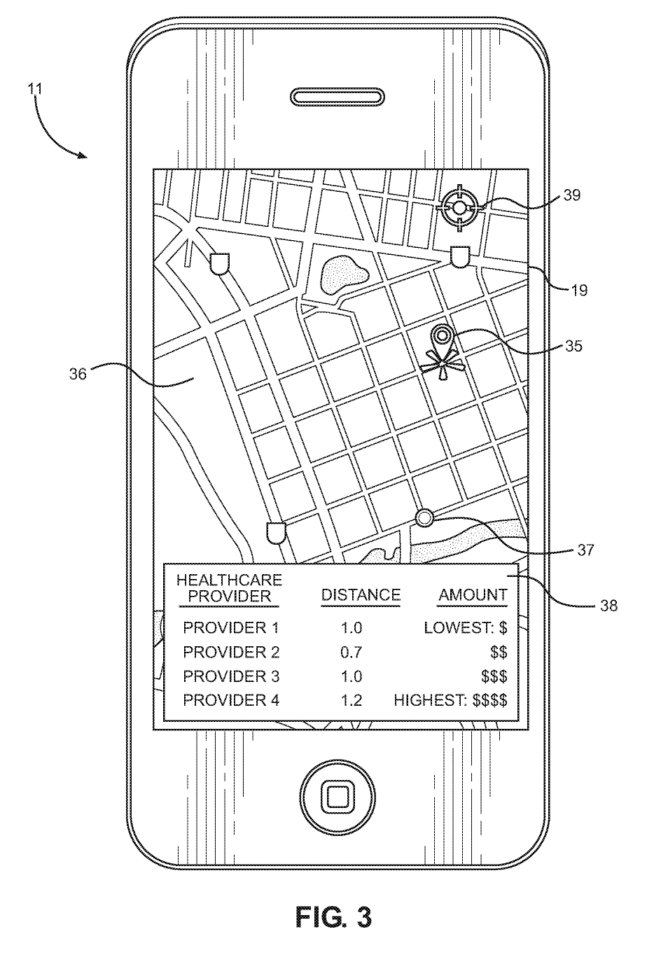

Referring now to FIG. 3, there is shown a graphical user interface on a display of the client computer displaying healthcare provide information. In the illustrated embodiment, the logic causes the GUI and display 19 of the client computer 11 to show a map 36 indicating the location of nearby healthcare providers 37 on the display 19. Further, the GUI includes a list of healthcare providers 38 at the bottom of the display 19. The list 38 is categorized by price, such that the lowest amount is listed at the top of the column and the highest amount is listed at the bottom. The location of the mobile device 35 is displayed on the map 36. The list 38 can further be categorized by distance to show the closet provider 37 relative to the mobile device's location 35. The user selects a desired healthcare provider 39 based on proximity or price. Once selected, the client computer 11 will display an optimal route of travel to the selected healthcare provider 39. The logic may be configured to display the route of travel on a map or as driving directions in a list format. The illustrated embodiment, allows a user to select the most affordable healthcare provider and further provides a travel route to the location of that healthcare provider.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A computer system for locating healthcare providers comprising:
a client computer having a processor;
a non-transitory computer readable medium operatively connected to the processor;
a logic stored in the non-transitory computer readable medium that, when executed by the processor, causes the client computer to perform a method, the method comprising:
transmitting a current location of the client computer determined by a GPS system to a server;
transmitting a series of criteria provided by a user to the server;
receiving a ranked list of healthcare providers from the server corresponding to the series of criteria and the current location of the client computer;
displaying the ranked list of healthcare providers by proximity to the current location of the client computer;
displaying the ranked list of healthcare providers, wherein each healthcare provider is assigned a monetary value based on a desired medical treatment.

2) The computer system of claim 1, wherein the performed method further comprises:
displaying an optimal travel route to a selected healthcare provider chosen from the ranked list of healthcare providers.

3) The computer system of claim 1, wherein the performed method further comprises:
transmitting a user profile containing medical information to the server;
receiving a ranked list of healthcare tips corresponding to medical information contained in the user profile from the server.

4) The computer system of claim 1, wherein the performed method further comprises:
transmitting a description of a health symptom entered by a user to the server;
receiving from the server a ranked list of diagnoses corresponding to the description of the health symptom.

5) The computer system of claim 1, wherein the performed method further comprises:
transmitting a medical treatment description with an assigned monetary value to the server, wherein the medical treatment description corresponds to medical treatment previously performed on a user by a healthcare provider and the monetary value corresponds to the price paid for the medical treatment received.

6) The computer system of claim 1, wherein the series of criteria comprises health insurance carrier information, geographic radius limits based on the location of the client computer, and pricing restrictions inputted by the user.

7) A computer-implemented method of locating healthcare providers comprising:
transmitting a current location of a client computer comprising a GPS system to a server;
transmitting a series of criteria provided by a user from the client computer to the server;
receiving the current location of the client computer and the series of criteria at the server, the server comprising a database having a list of healthcare providers, a list of corresponding healthcare provider locations, a list of ratings for each healthcare provider, and a list of corresponding medical treatment options available at each healthcare provider with a monetary value assigned to each medical treatment option;
compiling a list of healthcare providers based on proximity to the current location of the client computer and the series of criteria;
ranking the list of healthcare providers based on proximity to the current location of the client computer and the series of criteria;
transmitting a ranked list of healthcare providers based on proximity to the current location of the client computer and the series of criteria to the client computer;
receiving the ranked list of healthcare providers based on proximity to the current location of the client computer and the series of criteria from the server.
displaying the ranked list of healthcare providers by proximity to the current location of the client computer on the client computer; and
displaying the ranked list of healthcare providers sent by the server, wherein each healthcare provider is assigned a monetary value based on a desired treatment.

8) The method of claim 7, wherein the series of criteria comprises health insurance carrier information, pricing restrictions, and distance restrictions inputted by the user.

9) The method of claim 7, further comprising:
displaying an optimal travel route to a selected healthcare provider chosen from the ranked list of healthcare providers.

10) The method of claim 7, further comprising:
transmitting a user profile containing medical information from the client computer to the server;
receiving the user profile containing medical information at the server, wherein the server further comprises a database comprising a list of healthcare tips that correspond to a set of criteria provided in the user profile;
compiling a list of healthcare tips corresponding to medical information contained in the user profile;
ranking the list of healthcare tips corresponding to medical information contained in the user profile;
transmitting a ranked list of healthcare tips corresponding to the medical information contained in the user profile to the client computer;
receiving the ranked list of healthcare tips corresponding to medical information contained in the user profile from the server; and
displaying the ranked list of healthcare tips on the client computer.

11) The method of claim 7, further comprising:
transmitting a description of a health symptom entered by a user from the client computer to the server;
receiving the description of a health symptom at the server, wherein the server further comprises on the database a list of diagnoses corresponding to health symptoms;
compiling a list of diagnoses corresponding to the description of the health symptom entered by the user;
ranking the list of diagnoses corresponding to the description of the health symptom entered by the user;
transmitting a ranked list of diagnoses corresponding to the description of the health symptom entered by the use to the client computer;
receiving from the server the ranked list of diagnoses corresponding to the description of the health symptom;
displaying the ranked list of diagnoses on the client computer.

12) The method of claim 7, further comprising:
transmitting a medical treatment description with an assigned monetary value to the server, wherein the medical treatment description corresponds to medical care previously performed on a user by a healthcare provider and the monetary value corresponds to the price paid for the medical care received;
receiving the medical treatment description with the assigned monetary value at the server;
updating a list of corresponding treatment options available at each healthcare provider with a monetary value assigned to each treatment option database a diagnosis corresponding to the description of the health symptom entered by the user;

13) A non-transitory computer readable medium that, when executed by a processor of a client computer, causes the client computer to perform a method comprising:
transmitting a current location of the client computer determined by a GPS system to a server;
transmitting a series of criteria provided by a user to the server;
receiving a ranked list of healthcare providers from the server corresponding to the series of criteria and the current location of the client computer;
displaying the ranked list of healthcare providers by proximity to the current location of the client computer;
displaying the ranked list of healthcare providers, wherein each healthcare provider is assigned a monetary value based on a desired treatment.

14) The non-transitory computer readable medium of claim 13, wherein the performed method further comprises:
displaying an optimal travel route to a selected healthcare provider chosen from the ranked list of healthcare providers.

15) The non-transitory computer readable medium of claim 13, wherein the performed method further comprises:
transmitting a user profile containing medical information to the server;
receiving a ranked list of healthcare tips corresponding to medical information contained in the user profile from the server.

16) The non-transitory computer readable medium of claim 13, wherein the performed method further comprises:
transmitting a description of a health symptom entered by a user to the server;
receiving from the server a ranked list of diagnoses corresponding to the description of the health symptom.

17) The non-transitory computer readable medium 13, wherein the performed method further comprises:
transmitting a medical treatment description with an assigned monetary value to the server, wherein the medical treatment description corresponds to medical care previously performed on a user by a healthcare provider and the monetary value corresponds to the price paid for the medical care received.
